(19) United States
(12) Patent Application Publication
(10) Pub. No.: US 2023/0018963 A1
(43) Pub. Date: Jan. 19, 2023

(54) PROCESS FOR IMPROVING THE REPEATABILITY OF A WELD

(71) Applicant: FAURECIA SYSTEMES D'ECHAPPEMENT, NANTERRE (FR)

(72) Inventors: François Paul Pierre LECOESTER, MONTBELIARD (FR); Vincent GRABER, BAVILLIERS (FR)

(21) Appl. No.: 17/865,728

(22) Filed: Jul. 15, 2022

(30) Foreign Application Priority Data
Jul. 16, 2021 (FR) 21 07712

(51) Int. Cl. B23K 37/053

(52) U.S. Cl. CPC B23K 37/053; B23K 26/244

(57) ABSTRACT

A process is provided for welding an assembly of a first tubular component and a second tubular component, the first and second tubular components having first and second cylindrical portions, respectively. The process uses a pressing jig, a pressing tool, a welding jig and a welding head. The process includes: positioning the first tubular component with respect to the pressing jig; clamping the first tubular component against the pressing jig; freely fitting the second cylindrical portion into the first cylindrical portion, the two cylindrical portions being substantially coaxial; placing the second component with respect to the first cylindrical portion and the pressing jig; tightening the second tubular component against the pressing jig; aligning the two fitted cylindrical portions with the pressing tool; and pressing by plastic deformation the first and second cylindrical portions. The first and second pressed tubular components form a rigid assembly, with the two fitted and pressed cylindrical portions defining a fitting and a joint. Additional steps include: positioning the rigid assembly with respect to the welding jig; clamping the rigid assembly against the welding jig; and welding by positioning and orienting the welding head repeatably with respect to the fitting and the joint, where the rigid assembly is positioned with respect to the welding jig along one or more surfaces belonging exclusively to the first component in the pressed state.

### CROSS-REFERENCE TO RELATED APPLICATIONS

This application is a U.S. non-provisional application claiming the benefit of French Application No. 21 07712, filed on Jul. 16, 2021, which is incorporated herein by reference in its entirety.

### TECHNICAL FIELD

The disclosure relates to a process of welding a joint obtained by fitting together two tubular components. Such a process can be used in particular, for welding tubes and accessories used for guiding the gases of an exhaust line of an internal combustion engine.

The aim of the disclosure is to improve the repeatability of welding in order to provide a constant quality for weld beads when MIG/MAG, TIG or LASER technologies are used, in particular when such technologies are robotized.

### BACKGROUND

Arc and lap welding or laser lap welding of a circular joint is widely used in industry. In welding, two metallic tubular components each having a cylindrical portion are brought together and fitted in together, a first cylindrical portion partially covering a second cylindrical portion.

In the field of automotive exhaust, the materials suitable for such welding are varied, such as austenitic, ferritic or duplex steel. Such steels have excellent properties of resistance to corrosion and resistance to wear in service.

The pipes forming the exhaust line have a gas guiding function and a retaining function related to the depollution and attachment systems on the vehicle. The pipes have various shapes depending on the devices to be integrated and on the space available under the hood or under the body. They can be coupled to each other or to other parts of the vehicle by flanges.

Whenever the pipe thicknesses are small, i.e. comprised between 0.6 mm and 1.0 mm, the adjustment of the welding parameters may encounter limitations, in which case the arc welding technology can no longer be used to reduce in energy with respect to the thickness. One solution consists in adding material by interposing one or more sleeves between the cylindrical portions to be assembled. The sleeve may be directly mounted or else integral with the material typically by way of a roll-up. Rolling-up refers to the operation for the purpose of obtaining a double or even triple wall of the tube by turning over. The addition of material has the effect of increasing the possibilities of adjustment of the welding.

The constituent elements of the line, and in particular the pipes, are mainly welded using MIG/MAG lap welding technology. Same can also be welded using TIG lap welding technology or laser lap welding technology. Once finished, the welds must meet technical specifications and/or standards established on the basis of requirements of resistance to wear in service and further of leak-tightness. The leak-tightness requirements are more severe depending on whether the weld is upstream or downstream of depollution systems.

The problem therefore lies in the search for a process capable of guaranteeing the repeatability of a MIG/MAG or TIG lap welding or transparent laser welding, of a circular joint resulting from press-fitting, by controlling three main welding conditions, namely; the reduction of the pre-existing clearances at the joint, the positioning of the welding impact point, and finally the orientation of the welding head with respect to the circular joint and the press-fitting.

The problem further relates to productivity requirements relating to the reduction of manufacturing costs. Specifically, the mutual press-fitting of the two cylindrical tubular components including the sleeves and positioning thereof in the welding tool have to be performed within an acceptable cycle time.

Finally, the problem relates to the geometric conformity of the assembly. After welding, tolerances have to be satisfied by shape and position characteristics so as to ensure the feasibility of downstream operations and the functions of the final product.

In this context, it is known to implement a process of assembling components comprising cylindrical portions, the method comprising press-fitting operations with free adjustment, positioning on a jig, calibration and brazing. Such method solves several problems: free fitting allows the tubular components to be loaded in an acceptable cycle time. The positioning of the components in the jig provides geometrical conformity of the assembly. Calibration leads to a reduction in the clearance which enables the brazing process and the principle of using capillary forces.

It is also known to use a method to control an automatic fitting of two cylindrical tubular components, the components being handled by two corresponding robots. The method records the insertion force during fitting, compares same to a law linking the insertion force to the offset of the components, and calculates a correction value. The correction value is used for realigning the two components being press-fitted.

It is also known to implement a method of locating a joint by vision. Applied to the robotic lap welding of a circular joint, this method makes it possible to align the location of the welding impact points with the meeting line of the surfaces delimiting the joint independently of the variations of the position of the torch and/or the joint. Such vision-assisted automatic alignment contributes to weld repeatability.

However, the known processes and methods, even in combination, do not fully solve the problem of controlling the arc and lap welding conditions of a circular joint, whether or not the joint includes sleeves.

### SUMMARY

The subject disclosure provides an automatic method for welding an assembly comprising:

a. a first tubular component comprising at least one first pressing surface and a first cylindrical portion, said first cylindrical portion having a first outer surface and a first inner surface, the first outer and inner surfaces not belonging to the at least one first pressing surface,

b. and a second tubular component comprising at least one second pressing surface and a second cylindrical portion, said second cylindrical portion having a second outer surface and a second inner surface, the second outer and inner surfaces not belonging to the at least one second pressing surface,

the method involving:

c. a pressing jig comprising at least one first receiving surface and at least one second receiving surface,

d. a pressing tool apt to form the material radially along an axis S,

e. a welding jig comprising at least one third receiving surface,

f. and a welding head,

the process comprises the following steps:

g. positioning the first tubular component with respect to the pressing jig, placing the at least one first pressing surface in contact with the at least one first receiving surface,

h. clamping the first tubular component against the at least one first receiving surface so as to immobilize same,

i. freely fitting the second cylindrical portion of the second tubular component into the first cylindrical portion of the first tubular component, the second cylindrical portion being substantially coaxial with the first cylindrical portion,

j. placing the second tubular component with respect to the first tubular component and the pressing jig, bringing the at least one second pressing surface into contact with the at least one second receiving surface,

k. “sliding” clamping the second tubular component against the at least one receiving surface, the second tubular component being oriented by the receiving surface,

l. aligning the first and second fitted cylindrical portions with the axis S of the pressing tool,

m. pressing by plastic deformation, the first and second press-fitted cylindrical portions, the first and second tubular components in the pressed state forming a rigid assembly, the first and second press-fitted and pressed cylindrical portions defining a press-fit and a joint, the rigid assembly formed further comprising at least one third pressing surface,

n. positioning the rigid assembly with respect to the welding jig,

o. clamping the rigid assembly against the welding jig,

p. welding the first tubular component with the second tubular component by positioning and orienting the welding head repeatably with respect to the press-fit and the joint,

where the positioning of the rigid assembly with respect to the welding jig is achieved by bringing the at least one third pressing surface into contact with the at least one third receiving surface, the at least one third pressing surface belonging to the first tubular component, preferentially being identical to the at least one first pressing surface.

Particular features or embodiments, usable alone or in combination, are:

The process can include, prior to the step of positioning the first component, a step of sleeving at least the first or second inner surface and/or at least the first or second outer surface.

Pressing can be performed by shrinking the first cylindrical portion against the second cylindrical portion.

Pressing can be performed by an expansion of the second cylindrical portion against the first cylindrical portion.

Alignment and pressing can be performed simultaneously.

Welding can be a laser lap welding of the press-fit or an arc and lap welding of the joint.

The welding jig can be a component of the pressing jig.

The pressing jig and the welding jig can be distinct from each other, and the rigid assembly can be moved between pressing and welding.

The at least one third receiving surface can be substantially identical/common to the at least one first receiving surface.

In a second aspect, the disclosure proposes to implement a pressing apparatus comprising a frame, a pressing jig and a pressing tool, the pressing tool having a pair of jaws, said pair of jaws being movable with respect to the frame between a loading position and a working position, the pair of jaws in the working position defining an axis S, the pressing jig being further apt to receive first and second tubular components having first and second cylindrical portions, respectively, the second cylindrical portion being fitted freely into the first cylindrical portion, the two cylindrical portions being substantially coaxial, and wherein that the same comprises a system for aligning the fitted cylindrical portions with the axis S.

A particular characteristic of the pressing apparatus is that the pair of jaws is movable in translation with respect to the frame along an axis Z perpendicular to the axis S and wherein the alignment device includes at least one pivot connection mounted between the pressing jig and the frame, preferentially, at least one pivot connection along an axis P1, the axes P1, Z and S forming a rectangular trihedron, even more preferentially along two pivot connections along the corresponding axes P1 and P2, where the axes P1, Z and S form a rectangular trihedron, P2 being parallel to Z and intersecting with P1.

### BRIEF DESCRIPTION OF THE DRAWINGS

The disclosure will be better understood on reading the following description, given only as an example, and with reference to the enclosed figures wherein:

FIG. 1 shows, according to a first embodiment, a first tubular component,

FIG. 2 shows, according to the first embodiment, a second tubular component,

FIG. 3 shows, according to a variant of the first embodiment, a first tubular component,

FIG. 4 shows, according to the first embodiment, a pressing apparatus,

FIG. 5 shows, according to the first embodiment, a welding step,

FIG. 6 shows, according to a variant of the first embodiment, another welding step,

FIG. 7 shows, according to a second embodiment, a first tubular component,

FIG. 8 shows, according to the second embodiment, a second tubular component,

FIG. 9 shows, according to the second embodiment, a pressing apparatus,

FIG. 10 shows, according to the second embodiment, a welding step,

FIG. 11 shows, according to the first embodiment, a pressing apparatus comprising an alignment device.

### DETAILED DESCRIPTION

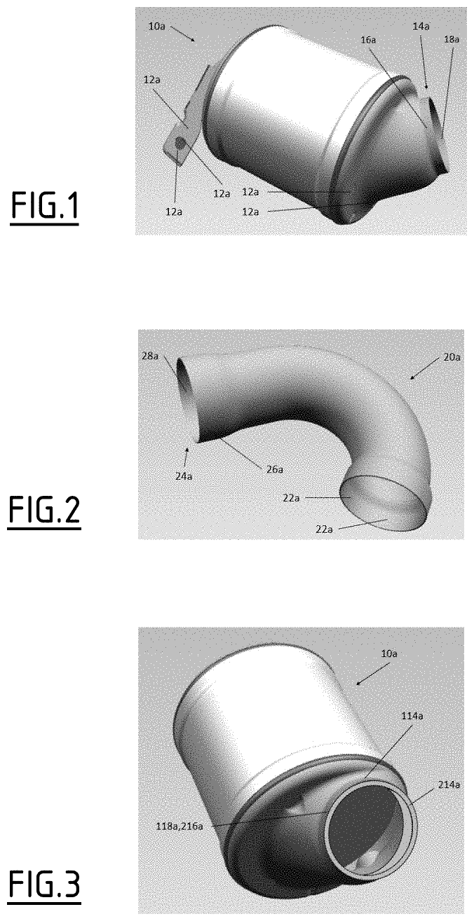

With reference to FIGS. 1, 2, 3 and according to a first embodiment, first and second tubular components 10a, 20a have first and second pressing surfaces 12a, 22a and respective first and second corresponding cylindrical portions 14a, 24a. The outer surfaces 16a, 26a and inner surfaces 18a, 28a of the first and second cylindrical portions 14a, 24a do not belong to the first and second pressing surfaces 12a, 22a.

The tubular components 10a, 20a are typically assembled for the manufacture of an exhaust line whose function is to guide and depollute gases. According to this first embodiment, the components are made of stainless steel, preferentially of ferritic stainless steel, even more preferentially of 1.4509 steel. The tubular components 10a, 20a can have a large thickness, typically comprised between 1.0 mm and 2.5 mm, or else a small thickness comprised between 0.6 and 1.0 mm.

The cylindrical portion 14a is a surface of revolution and has an inside diameter D1 typically comprised between 40 mm and 80 mm.

The cylindrical portion 24a is a surface of revolution and has an outside diameter of typically between 40 mm and 80 mm.

The portions 14a, 24a also have corresponding cylindricity defects Ci, which are typically equal to 0.6 mm.

With reference to FIG. 1, the first component 10a comprises a drawing barrel 14a with a thickness substantially equal to 1.2 mm and a length of 8.0 mm.

With reference to FIG. 3 and according to a variant of the component, the first tubular component 10a includes a cylindrical portion 14a comprising a drawing barrel 114a in material continuity with the tubular component 10a, and a sleeve 214a coupled from the inside to the drawing barrel 114a. The barrel 114a has an inner surface 118a and the sleeve has an outer surface 216a. The coupling is performed for bringing the outer surface 216a into contact with the inner surface 118a. According to this variant, the drawing barrel 114a has a thickness substantially equal to 0.8 mm and a length of 8.0 mm. The sleeve 214a has a thickness equal to 1.0 mm and a length of 10.0 mm Coupling is achieved by fitting the sleeve 214a inside the barrel 114a, then by expansion, the circular ends of the barrel 114a and of the sleeve 214a being flush, the clearance between the inner surface 118a and the outer surface 216a being substantially equal to zero. Advantageously, the barrel and the sleeve are spot welded after expansion, so as to maintain the coupling.

With reference to FIGS. 1, 2, 3 and 4 and according to the first embodiment, the method of assembling the first component 10a with the second component 20a uses a pressing apparatus including a pressing jig 30a and a pressing tool 40a. The pressing jig 30 has first and second receiving surfaces 32a, 34a. The pressing tool is apt to radially form the material along an axis S. The process comprises successive operations of: positioning and clamping the first component 10a; free fitting of the second cylindrical portion 24a in the first cylindrical portion 14a; placing and ‘sliding’ clamping of the second component 20a; aligning the two cylindrical portions 14a, 24a with the axis S; and finally pressing the first component 10a against the second component 20a.

According to a first operation, the first tubular component 10a is positioned with respect to the pressing jig by bringing the first pressing surfaces 12a into contact with the first receiving surfaces 32a. The tubular component 10a is then clamped against the first receiving surfaces 32a. “Clamped” means that the component 10a is immobilized with respect to the pressing jig 30a.

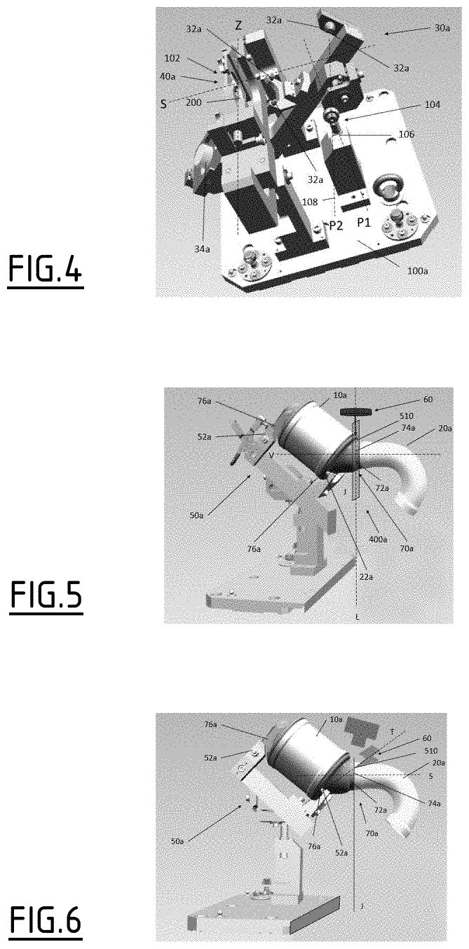

With reference to FIG. 4, the first pressing surface 12a and receiving surface 32a create the conditions for isostatic positioning of the component 10a by blocking the six degrees of freedom thereof and a suitable clamping sequence immobilizes the component 10a with respect to the pressing jig. A part of the first pressing surfaces 12a is typically used to position and mount the exhaust pipe under the vehicle body.

According to a second operation, the second cylindrical portion 24a is fitted freely into the first cylindrical portion 14a in a substantially coaxial manner, the cylindrical portion 14a not including the sleeve 214a. In order to satisfy the conditions of a free fitting of the two cylindrical portions 14a, 24a, it is usual to provide an assembly clearance JA greater than 0.1 mm. The assembly clearance JA is a function of the diameters and of the cylindricity defects of the cylindrical portions 14a, 24a according to the formula: JA=(Di−Ci/2)−(de+ce/2).

According to a third operation, the second component 20a is placed with respect to the first component 10a and to the pressing jig 30a by bringing the second pressing surfaces 22a into contact with the second receiving surfaces 34a. After the placement, the second component 6a is “sliding” clamped against the pressing jig 30a along the second receiving surfaces 34a. “Sliding” clamped means that displacements between the second pressing surfaces 22a and the second receiving surfaces 34a, and between the first inner surface 18a and the second outer surface 26a, are made possible during pressing.

According to a first mode of placing the second component 20a and with reference to FIG. 4, the assembly clearance JA is chosen so that the second component 20a has two degrees of freedom along the radial directions of the fitting. Only four degrees of freedom of the second component 20a are blocked, the component 20a thus being in a pre-positioned state. The locking of the four degrees of freedom is typically achieved by imposing a long centering between the pressing surfaces 22a and the receiving surfaces 34a. Centering has the effect of orienting and positioning the second component 20a for downstream assembly operations. Clamping of the second component 20a against the second receiving surfaces 34a can be obtained by using an expansible mandrel or a centering sleeve whether or not equipped with ball pushers.

Such way of positioning which involves a ‘floating’ positioning of the second component 20a with respect to the first component 10a and to the pressing jig 30a is useful when the first and second components 10a, 20a have large geometrical defects.

According to a second mode of placement, the assembly clearance JA is chosen to create the conditions for a short centering of the second cylindrical portion 24a with respect to the first cylindrical portion 14a. Two degrees of freedom of the second component 6a are thus blocked. An isostatic positioning of the second component 20a is achieved by blocking four additional degrees of freedom typically via long centering of the pressing surfaces 22a with respect to the receiving surfaces 34a.

Such variant of placement involving an isostatic positioning of the second component 20a with respect to the first component 10a and to the pressing jig 30a requires the use of first and second components 10, 20a with reduced geometric defects.

With reference to FIG. 4, a pressing apparatus comprising a pressing jig 30a and a pressing frame 100a integrates a pressing tool 40a rigidly attached to the frame 100a, the pressing tool 40a having a pair of clamps 102 movable in translation along an axis Z between a loading position C and a working position T. In the working position, the close jaws define an axis S.

According to a fourth operation, the first and second cylindrical portions 14a, 24a fitted together are aligned with the pressing tool 40a. The axes of the two cylindrical portions 14a, 24a are thus directed along S. The alignment of the cylindrical portions 14a, 24a in the state where same are fitted with the pair of clamps 102 in the working position T uses an articulation 104 comprising pivot connections 106, 108 along the axes P1 and P2, the pivot connections being mounted between the frame 100a and the jig 30a.

Indeed, the fitted cylindrical portions 14a, 24a which are pre-aligned with the pair of clamps 102 in the loading position C, are completely aligned in the working position T. The displacement of the cylindrical portions 14a, 24a with respect to the frame 100a and to the clamps 102 during pressing is achieved via the articulation 104 which includes the pivot connections 25, 26. The device 104 also has the effect of simultaneously aligning and pressing the components 10a, 20a.

According to a fifth operation and with reference to FIG. 4, the pressing is performed by shrinking the first cylindrical portion 14a onto the second cylindrical portion 24a. The pressing tool 40a rigidly attached to the frame 100a uses the pair of clamps 23 movable with respect to the frame 22, the pair of clamps 102 comprising a pair of jaws 200. Said jaws 200 have a cylindrical shape, the dimensions of which are correlated with the dimensions of the cylindrical portion 14a.

If the outside diameter of the cylindrical portion 14a in the free state is De, then the diameter of the jaws 200 will be chosen to be less than or equal to De−X, each of the jaws 200 extending over a sector equal to 180−Y degrees, De typically being comprised between 40 and 80 mm, X being typically equal to 0.6 mm, Y typically equal to 2 degrees. The thickness of the jaws 200 is chosen to be substantially smaller than the length of fitting of the cylindrical portions 14, 24, i.e. typically 5.0 mm.

Closing the clamps 102 on the cylindrical portions 14a, 24a in the fitted state leads to a substantially radial plastic deformation of the two components 10a, 20a. A clamping force associated with such plastic deformation is created, which makes it possible to rigidly hold the two cylindrical portions 14a, 24a therebetween and, by extension, the two components 10a, 20a therebetween. When the thickness of the first cylindrical portion is small, the clamping force is insufficient for providing rigidity to the pressed assembly. One solution is comprised of, according to a variant of component, using a first formed cylindrical portion 14a of a drawing barrel 114a and a sleeve 214a assembled from the inside. Thus, the clamping force associated with the deformation of the sleeve 214a is added to the force of the drawing barrel 114a and the result is that the two components 10a, 20a are being held rigidly therebetween.

With reference to FIGS. 5 and 6, the pressing of the components 10a, 20a defines the rigid assembly 70a, the fitting 72a and the substantially circular joint 74a.

The first five process operations have advantages:

The fitting 72a has a variable position with respect to the first component 10a and to the pressing jig 30a, as a consequence of manufacturing dispersions. This variable position does not disturb the correct alignment of the fitting 72a with the pressing tool 14a, the alignment being provided by the articulation 104. The rigid retaining of the two components 10a, 20a therebetween, which depends predominantly on the alignment, is thus provided.

With the rigid assembly 70a thus achieved, the positions of the second pressing surfaces 22a of the second component 20a in the pressed state are repeatable with respect to the jig 30a and hence repeatable with respect to the first pressing surfaces 12a. The geometry of the rigid assembly 70a is conformal and repeatable.

The resulting clearance JS of the pressing between the two cylindrical portions 14a, 24a at the circular joint 74a is typically less than 0.2 mm Such a clearance is the guarantee of repeatable welding regardless of the technology used: MIG/MAG, TIG lap welding or transparent laser welding.

With reference to FIGS. 5 and 6 and according to the first embodiment, the method of assembling the first component 10a with the second component 20a uses a welding apparatus comprising a welding jig 50a and a welding head 60, where the welding jig 50a includes third receiving surfaces 72a. The method comprises successive operations of: positioning and clamping the rigid assembly 70a onto the welding jig 50a; welding the first component 10a with the second component 20a; the welding head 60 being positioned and oriented with respect to the fitting 72a and to the joint 74a. The welding head is positioned and oriented in particular with respect to the center of the substantially circular joint 74a and to the plane J wherein same is inscribed.

According to a sixth operation and with reference to FIGS. 5 and 6, the third pressing surfaces 76a of the assembly 70a are identical to the first pressing surfaces 12a of the first component 10a. The assembly 70a is therefore positioned with respect to the welding jig 50a by bringing the first pressing surfaces 12a into contact with the third receiving surfaces 52a.

Typically, the contact between the first pressing surface 12a and the receiving surface 52a creates the conditions for an isostatic positioning of the rigid assembly 70a by blocking the six degrees of freedom thereof. A suitable clamping sequence makes it possible to immobilize the assembly 70a.

According to the first embodiment and a way of first positioning, the welding jig 50a is a component of the pressing jig 30a, the third receiving surfaces 52a being common/identical to the first receiving surfaces 32a. A supplementary module 500 is therefore added to the welding jig 50a, the assembly forming the pressing jig 30a. The contact between the first pressing surfaces 12a and the first receiving surfaces 32a is maintained between pressing and welding. The work-station is thus common to both pressing and welding. Same comprises a frame 100a, a jig 30a, 50a, 500, a welding tool 30a and a welding head 60. A first device, not shown, enables the joint 104 composed of the pivot connections 106,108 to be blocked prior to welding. A second device, not shown, can be used for separating the supplementary module 500 from the pressing frame 100a and to retract same out of the welding environment. A third device (not shown) can be further used for separating the pressing tool 40a and to retract same out of the welding environment.

According to a second way of positioning the rigid assembly 70a, the pressing jig 30a and the welding jig 50a are distinct. The assembly 70a is thus moved between a pressing station and a welding station. The third receiving surfaces 52a are identical to the first receiving surfaces 32a. The contact of the first pressing surfaces 12 with the first receiving surfaces 32a used for pressing is reproduced during welding. The third receiving surfaces 52a and the first pressing surfaces 12a create the conditions for an isostatic positioning of the assembly 70a with respect to the welding jig 50a.

According to a seventh operation and with reference to FIGS. 5 and 6, the first component 10a in the pressed state is welded with the second component 20a in the pressed state, the welding head 60 being positioned and oriented favorably, with respect to the fitting 72a and to the substantially circular joint 74a.

According to the first embodiment and a first welding mode, with reference to FIG. 5, the fitting 72a is welded by transparent laser welding. Typically, the welding uses a LASER head 60 oriented along an axis L, the LASER beam encountering the fitting 72a along an impact point 510, the outer surface 16A of the fitting 72a being substantially normal to the axis L at the point of impact 510 and spaced out from the welding head 60 by a value DF. A rotator (not shown) provides full rotation of the fitting 72a about an axis V which is substantially perpendicular to the axis L and substantially merged with the axis of the fitting 72a. A method using vision-recognition of the joint is used for maintaining the focal length DF constant during rotation and welding.

According to a second way of welding and with reference to FIG. 6, arc welding and lap welding are used, the welding head 60 including an electrode 520, the welding using a method allowing said electrode 520 to be aligned with the joint 74a. Typically, a MIG/MAG or TIG welding torch having an axis T is approached and directed toward an impact point 510 at three angles. The axis T projected onto the plane J forms a first angle with the normal at the point of impact 510, the angle determining if the weld is pushed or pulled. The axis T forms a second angle with the axis of the fitting 72a, the adjustment of which adjusts the penetration of the weld bead. The center of the circular joint 74a and the point of impact 510 define a direction forming a third angle with the horizontal, on which depends the arrangement of the weld puddle with respect to the axis T of the torch.

According to such welding variant and advantageously when the application is robotized, a method of aligning the point of impact of the welding 510 with the joint 74a is implemented. The method can use vision-recognition of the joint: The position of the joint 74a is calculated and a trajectory offset instruction is communicated to the robot carrying the torch. A position accuracy of the electrode with respect to the joint, of less than 1.0 mm, can be obtained.

The sixth and seventh operations and the variants thereof have the following advantages:

The pressing surfaces 76a of the rigid assembly 70a have been chosen to be identical to the pressing surfaces 12a of the component 10a. The receiving surfaces 52a for the assembly 70a were also chosen to be identical/common to the receiving surfaces 32a of the first component.

It is thus possible to design a welding jig 50a offset with respect to the fitting 72a and to the second component 20a. The welding jig 72a is typically mounted on a rotator (not shown) which rotates the fitting 72a about an axis V which substantially merged with the axis of the fitting 34a.

Under such conditions, the position and orientation of the welding head 60 can be chosen favorably and independently of the angular position of the point of impact 510. This ease of access of the welding head 60 with respect to the joint 74a contributes to the repeatability of the welding.

Typically and according to the first embodiment describing a LASER welding operation, the direction of the welding head 14 is maintained vertical throughout the rotation of the rigid assembly 70a and hence of the fitting 72a. No part of the welding jig describes a trajectory likely to interfere with the welding head 60 oriented along the L axis.

Typically and according to the second mode describing an implementation of MIG/MAG or TIG welding, the position of the point of impact 510 and the orientations of the torch along the axis T can be chosen favorably and optimally, where the half-space delimited by the plane J of the joint 74a extending toward the second component 20a, is left free of interference with the welding jig 50a and the rotator during the rotation thereof.

According to the first way of positioning the assembly 70a, the pressing jig 30a and the welding jig 50a have a common part used to position the first component 10a during pressing and the assembly 70a during welding. The pressing jig is designed in a modular manner for receiving the pressing tool 40a and the supplementary module 35. Such a design avoids the displacement of the assembly 70a between pressing and welding and has the advantage of saving time. In return, the design involves a modularity of the common tool 30a, 50a.

According to the first mode of positioning of the assembly 70a, the blocking of the articulation 104 formed by the pivot connections 106, 108, creates the conditions for an alignment between the axis of the fitting 72a and the pair of clamps 102 in the working position. The rotator (not shown) on which the welding tool 50a is mounted, has an axis of rotation aligned with the pair of clamps 102. A strict alignment is thus obtained between the axis of the fitting 72a and the axis of the rotor.

The alignment can be further obtained according to the second way of positioning of the assembly 70a.

In all cases, the alignment of the axes of the fitting 72a and of the rotor leads to a reduction of the runouts measured at the first outer surface 16a and at the circular joint 74a. Such runout reduction facilitates the positioning of the welding head 60 with respect to the fitting 72a and to the circular joint 74a. The conditions of this positioning contribute to the repeatability of welding.

According to the first embodiment of the welding wherein a LASER welding is performed, the half-space delimited by the plane J of the joint 74a extending toward the second component 20a is left free of interference during rotation. The method using vision-recognition of the joint so as to maintain a constant focal length DF during welding is thus made easier.

According to the second welding mode wherein MIG/MAG or TIG welding is performed, the half-space delimited by a plane J of the joint 74a and extending toward the component 4a, is left free. The method of aligning the point of impact 510 with the joint 74a based on vision-recognition of the joint is also made easier.

Taken as a whole, the process which comprises seven operations is the solution to the problem addressed, regardless of the main embodiment or the variants considered:

q. The clearance of less than 0.2 mm associated with pressing creates the conditions for repeatable welding regardless of the technology used; MIG/MAG lap welding, TIG lap welding or transparent laser welding.

r. Aligning the fitting 72a and/or the circular joint 74a with the axis of the rotator makes easier the correct positioning of the welding head 60 with respect to the targeted point of impact 510. The absence of interference between a vision and the circular joint further creates the conditions for an optimal detection of the weld joint. The location of the points of impact 510 can thus be positioned in the desired manner, coinciding with the circular joint 74a for MIG/MAG welding or of the TIG lap welding, according to a circular line on the surface 16a for transparent laser welding.

s. The half-space delimited by the plane of the joint 74a and extending toward the second component 20a left free can be used for orienting the welding head 60 favorably and optimally with respect to the fitting 72a and to the circular joint 74a, whatever the technology used.

t. Free fitting can be performed in an acceptable cycle time and can be made automatic.

u. The rigid assembly can be handled, typically by a robot.

v. Four degrees of freedom of the second component 20a are blocked and the pressing surfaces 22a can be chosen so as to satisfy the geometrical tolerances necessary for correctly performing the downstream operations and the final assembly.

w. The assembly can be made automatic and the welding process is repeatable.

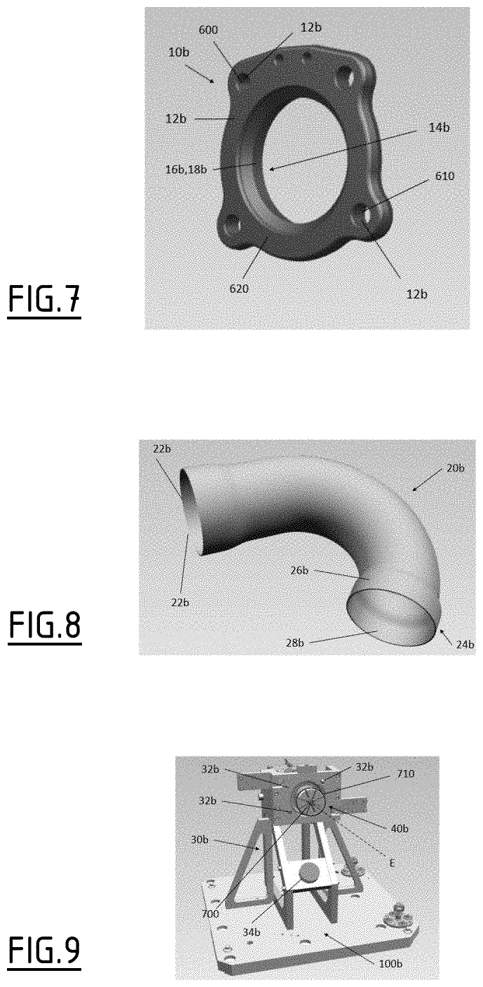

With reference to FIGS. 7, 8 and according to a second embodiment, first and second tubular components 10b, 20b have first and second pressing surfaces 12b, 22b and corresponding first and second cylindrical portions 14b, 24b. The outer surfaces 16b, 26b and inner surfaces 18b, 28b of the first and second cylindrical portions 12b, 22b do not belong to the first and second pressing surfaces 12b, 22b.

The tubular component 10b is a mounting flange of cast and machined steel. Same includes a barrel 14b with a thickness of 1.0 mm and a length of 5.0 mm. The inner diameter of the barrel 14b is 60.0 mm and the outer diameter is 62.0 mm. The pressing surfaces 12b are contained within the surfaces of a first bore 600, a second bore 610 and of a mating surface 620.

The outside and inside diameters De, Di of the barrel can be comprised within a 40, 80 mm interval.

The outer surfaces 16b and inner surfaces 18b of the barrel 12b have cylindricity defects Ce, Ci equal to 0.1 mm.

The material used is typically a 1.4511 stainless steel.

The second tubular component 20b is a bent tube with two cylindrical ends obtained by radial expansion, one end supporting the second pressing surface 22b, the other end delimiting the second cylindrical portion 24b. The thickness of the tube 20b can be comprised in the interval 1.0 mm to 2.5 mm. The outer and inner diameters de, di of the tube 20b can be comprised between 40 mm and 80 mm.

The outer surface 26b and the inner surface 28b of the second cylindrical portion 24b typically have cylindricity defects ce, ci equal to 0.6 mm.

The tube 20b is made of ferritic stainless steel, more precisely a 1.4509 stainless steel.

With reference to FIGS. 7, 8 and 9 and according to a second embodiment, the method of assembling the machined flange 10b with the bent tube 20b uses a pressing apparatus comprising a pressing jig 30b and a pressing tool 40b. The method comprises successive operations of; positioning and clamping the first component 10b; freely fitting the second cylindrical portion 24b into the first cylindrical portion 14b; placing and clamping the second component 20b; aligning the two cylindrical portions 14b, 24b with the pressing tool 30b; plastic expansion of the second component 20b against the first component 10b.

According to a first operation, the flange 10b is positioned with respect to the pressing jig 30b by bringing the first pressing surfaces 12b into contact with the first receiving surfaces 32b. The pressing surfaces 12b typically belong to reference surfaces of a final assembly (not shown). The first receiving surfaces 32b delimit a centering device, an anti-rotation element or keys, and mate with the pressing surfaces 12b, 600, 610, 620. The flange 10b is then immobilized by clamping against the first receiving surfaces 32b.

According to a second operation, the second cylindrical portion 24b is freely fitted into the barrel 14b, the two cylindrical portions 14b, 24b being substantially coaxial. In order to satisfy the conditions of a free fitting of the two cylindrical portions 14b, 24b, it is known to choose the diameters of the two cylindrical portions as a function of the corresponding lack of cylindricity thereof and of an assembly clearance JA. Typically, the assembly clearance JA=(Di−Ci/2)−(de+ce/2) will be chosen to be greater than or equal to 0.1 mm.

According to a third operation, the second component 20b is placed with respect to the first component 10b and to the pressing jig 30b by placing the second pressing surface 22b in contact with the second receiving surface 34b. After placement, the second component 4b is ‘sliding’ clamped against the pressing jig 30b with respect to the second receiving surface 34b. “Sliding” clamped means that the displacements between the second pressing surface 22b and the second receiving surface 34b and between the first inner surface 18b and the second outer surface 26b are made possible during expansion.

The assembly set JA is chosen to create the conditions for a short centering of the calibrated portion 24b with respect to the barrel 14b. Two degrees of freedom of the bent tube 20b are blocked. Isostatic positioning of the second component 20b is obtained by blocking four additional degrees of freedom typically by using a long centering associating the pressing surface 22b with the receiving surface 34b.

Clamping of the bent tube 20b against the second receiving surface 34b can be achieved by an expansible mandrel or a centering sleeve whether or not equipped with ball pushers.

With reference to FIG. 9, a pressing apparatus comprises a frame 100b, a pressing jig 30b and a pressing tool 40b mounted directly on the frame 100b. The tool 40b uses a set of segments 700 movable radially along an axis E between a loading position C and a working position T. The barrel 14b is aligned with the axis U when the flange 10b is loaded onto the tool 40b.

According to a fourth operation, the cylindrical portions 14b, 24b substantially aligned after fitting are strictly aligned after a first radial displacement of the set of segments 700. During such first radial displacement, the calibrated portion 24b can be deformed in the elastic range. The clamping and long centering associating the pressing surface 22b with the receiving surface 34b remain retained.

According to a fifth operation and with reference to FIG. 9, the pressing is performed by an expansion of the cylindrical portion 24b against the barrel 14b, by using a consecutive second radial displacement following the first. During the second radial displacement, the cylindrical portion 24b is plastically deformed and the outer surface 26b of the bent tube 20b comes into contact with the inner surface 18b of the flange 10b. A repeatable clearance JS is created at the interface of the outer surface 26b and inner surface 18b.

The movable segments 700 are actuated by a blade (not shown) and are spaced apart regularly by an elastic element (not shown). In the loading position C, the blade is retracted and exerts no force on the segments 700. The peripheral surfaces of the regularly spaced segments 700 are inscribed in a cylindrical envelope 710 whose dimensions are correlated with the dimensions of the cylindrical portion 24b. Typically, in the loading position C, the envelope 710 is contained in a cylinder with a diameter smaller than di-ci/2, the length of the segments 700 being correlated with the length of the cylindrical portion 24b.

Given the thickness of the bent tube 20b, the plastic deformation makes it possible to rigidly retain the calibrated end 24a via the barrel 14b and by the extension of the bent tube 20b via the flange 10b.

The components 10b, 20b in the pressed state define a rigid assembly 70b, a fitting 72b and a substantially circular joint 74b. The rigid assembly has third receiving surfaces 76b.

The first five operations of the method according to the second embodiment have advantages:

x. The assembly 70b can be handled by a single gripper.

y. The position of the second pressing surface 22b of the second component 20b in the pressed state is repeatable with respect to the jig 30b and thus repeatable with respect to the first pressing surfaces 12b. The second cylindrical portion 24b is positioned in a conformal manner with respect to the first pressing surfaces 12b which can advantageously serve as a reference surface for downstream operations.

z. The clearance JS obtained by pressing the two cylindrical portions 14b, 24b at the circular joint 74b is less than 0.2 mm Such a clearance is the guarantee of repeatable welding regardless of the technology used: MIG/MAG, TIG lap welding or transparent laser welding.

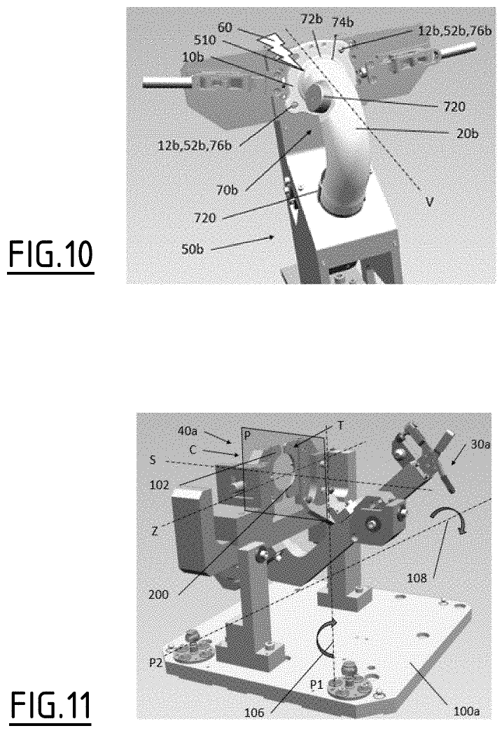

With reference to FIGS. 7, 8, and 10 and according to the second embodiment, the method of assembling the first component 10b with the second component 20b uses a welding apparatus comprising a welding jig 50b and a welding head 60. The process comprises successive operations of; transferring the rigid assembly 70b from the pressing station to the welding station; positioning and clamping the assembly 70b on the welding jig 50b, welding the second component 10b in the pressed state with the first component 20b in the pressed state, the welding head 60 being positioned and oriented favorably with respect to the fitting 72b and to the joint 74b.

According to a sixth operation, the assembly 70b is removed from the pressing jig 30b and then moved toward the welding jig 50b to be positioned. The transfer may be manual or advantageously automated.

According to a seventh operation and with reference to FIGS. 7, 8, and 10, the assembly 70b has third pressing surfaces 76b identical to the first pressing surfaces 12b of the first component 10b. More precisely, the assembly 70b is positioned on the welding tool 50b by centering the bore 600, by blocking a rotation on the bore 610 and by blocking 3 translations on the mating surface 620 via the receiving surfaces 52b.

Protective systems 720 are incorporated into the welding jig for protecting the working surfaces on which the presence of weld spatter is not acceptable. Such protections do not modify the positioning conditions of the assembly 70b, such as described in the disclosure.

In the same spirit, an anti-vibration feature (not shown) can be added to the jig 22b in order to stabilize the position of the assembly 70b during the rotations thereof. The anti-vibration feature does not modify the conditions of positioning the assembly 70b either, such as described in the disclosure.

After positioning, the assembly 70b is immobilized by a clamp 730.

According to an eighth operation, and with reference to FIGS. 7, 8 and 10, the flange 10b in the pressed state is welded to the bent tube 20b in the pressed state, the welding head being positioned and oriented favorably with respect to the fitting 34b and to the substantially circular joint 18b.

A robotic MIG/MAG lap welding is used and the welding is performed in two half-beads. For this purpose, the welding jig 50a is mounted on a rotator apt to angularly position the welding jig 50a about an axis V.

Since the flange 10b is machined with precision after molding, the barrel 14b and hence the joint 74b having a variation in positioning of less than 0.2 mm with respect to the welding jig 50b. The welding head 60, a torch in the case of MIG/MAG welding, mounted on a robot arm, also has a variation in position of less than 0.7 mm Under such conditions, the positioning of the electrode 520, a filler wire in the case of MIG/MAG welding, with respect to the joint 74b, is less than 1.0 mm Such positioning accuracy is sufficient to ensure the repeatability of the welding. The use of a vision-aligning the head 60 with the joint 74b e.g. is not necessary in such a case. The welding head 60 is directed toward a point of impact 510 whose location is substantially coincident with the circular joint 74b. Advantageously, the axis of the fitting 72b and hence of the circular joint 74b is aligned with the axis V of the rotator. The precision of the machining makes it possible to obtain an axis of the barrel 14b and hence of the fitting 72b, almost coaxial with the axis of the rotator

The sixth, seventh and eighth operations have the following advantages:

aa. The pressing surfaces 76b of the assembly 70b have been chosen to be identical to the pressing surfaces 12b of the component 10b. The receiving surfaces 52b of the assembly 70b were also chosen to be identical/common to the receiving surfaces 32b of the first component.

Such feature advantageously makes it possible to design the welding jig 50b with clearances which make the access to the MIG/MAG torch easy. The jig 50b is typically mounted on a rotator (not shown) which allows the fitting 72b to rotate about an axis V of the rotator, coaxial with the axis of the fitting 72b. The welding head 60 can be positioned and oriented favorably whereas being strictly compliant with the rules of the art, independently of the point of impact 510 of the welding. Such access conditions for the welding head contribute to the repeatability of welding.

bb. The welding in two half-beads makes it possible to program the trajectory of the torch so that same avoids the part of the welding tool 50b supporting the protection systems 720 without violating the rules of positioning and orientation of the welding head.

cc. The axis of the fitting 72b is aligned with the axis S of the rotator, which leads to a reduction of the runout considered at the circular joint 74b. This low level of runout contributes to the repeatability of welding.

Taken as a whole, the process according to the second embodiment, comprises eight operations and is the solution to the problem addressed:

dd. The clearance of less than 0.2 mm associated with expansion creates the conditions for repeatable welding given the MIG/MAG lap welding technique used.

ee. The alignment of the circular joint 74b with the axis V of the rotator and the positioning accuracy thereof with respect to the jig 13b, makes the alignment of the welding head 14 with the circular joint 74b, accurate and repeatable without the use of a method using vision-recognition for the joint.

ff. The half-space delimited by the plane of the joint 74b and extending toward the second component 20b left mainly free and the welding in two half-beads, make it possible to orient the welding head 60 with respect to the circular joint 74b whereas strictly following the rules of the art.

gg. Free fitting can be performed in an acceptable cycle time and can be made automatic.

hh. The fitted and pressed assembly can be handled.

ii. Four degrees of freedom of the second component 20b are blocked and the pressing surfaces 22b can be chosen so as to achieve the geometric tolerances related to the downstream operations and to the mounting on a vehicle.

jj. The assembly can be made automatic and the welding process is repeatable.

With reference to FIGS. 1, 2 and 11 and according to a first embodiment, a pressing apparatus comprises a frame 100a, a pressing tool 40a with a pair of clamps 102. The pair of clamps 102 is movable between a loading position C and a working position T, in translation along an axis Z with respect to the frame 100a and symmetrically along a plane P perpendicular to the axis Z.

The pair of clamps 102 comprises a pair of jaws 200 which defines, in the working position, a pressing axis S, the axis S being perpendicular to the axis Z and belonging to the plane P.

The pressing apparatus further comprises a pressing jig 30a designed to receive first and second tubular components 10a, 20a which have corresponding cylindrical portions 14a, 24a, said cylindrical portions 14a, 24a being fitted during loading. The pressing apparatus further comprises a device 104 for aligning the cylindrical portions 14a, 24a fitted with the pair of clamps 102 in the working position.

With reference to FIG. 11, alignment is obtained by combining the rotational movements made possible by a first pivot connection 106 along an axis P1 parallel to Z and by a second pivot connection 108 along an axis P2, where the axes P1, P2 and S form a rectangular trihedron.

Before pressing and in production mode, the cylindrical portions 14a, 24a are positioned from one assembly to another with respect to the pressing tool 40a, with a consecutive variability of manufacturing tolerances. A clamping device (not shown) acting on the jig 30a makes it possible to obtain a pre-alignment of the cylindrical portions 14a, 24a with the clamps 102. During pressing, the clamps 102 close and force strict and simultaneous alignment of the portions 14a, 24a, the alignment being made possible by the articulation 104 involving the pivot connections 106,108.

The pressing of the cylindrical portions 14a, 24a defines a rigid assembly 70a and a fitting 72a. A blocking device (not shown) for the articulation 104 makes it possible to obtain a repeatable position of the fitting 72a along the axis S.

The alignment of the cylindrical portions 14a, 24a with the clamps 102 is a condition for repeatably using the pressing. The absence of such an alignment device would be a source of defects likely to jeopardize the rigidity of the assembly 70a and to weaken the press-fit 72.

The repeatable orientation of the fitting 72a along the axis S advantageously makes welding easier when the welding jig is a component of the pressing jig 50a.

The disclosure has been illustrated and described in detail in the drawings and the preceding description. Same should be considered as illustrative and given as an example and not limiting the disclosure to this one description. Numerous variants of embodiments are possible.

### LIST OF REFERENCE SIGNS

10a, 10b first tubular component
12a, 12b at least one first pressing surface
14a, 14b first cylindrical portion
16a, 16b first outer surface
18a, 18b first inner surface
20a, 20b second tubular component
22a, 22b at least one second pressing surface
24a, 24b second cylindrical portion
26a, 26b second outer surface
28a, 28b second inner surface
30a, 30b pressing jig
32a, 32b at least one first receiving surface
34a, 34b at least one second receiving surface
40a, 40b pressing tool
50a, 50b welding jig
52a, 52b at least one third receiving surface
60 welding head
70a, 70b rigid assembly
72a, 72b fitting
74a, 74b joint
76a, 76b at least one third pressing surface
100a, 100b pressing frame
102 pair of clamps
104 alignment device
106 first pivot connection
108 second pivot connection
114a drawing barrel
118a inner surface of the drawing barrel
126a outer surface of the sleeve
200 pair of jaws
214a sleeve
400 rotator
500 supplementary module
510 point of impact
520 electrode
600 first bore
610 second bore
620 mating surface
700 set of segments
710 cylindrical envelope
720 protective systems
730 clamp

### List of Abbreviations

C Load position of the tool
T Working position
S Pressing axis
Z Translation axis
P1 Pivot axis
P2 Pivot axis
E Fitting axis
J circular mating face
L Axis of THE LASER beam
V rotator axis
De, Di outer/inner diameter of the first cylindrical portion
de, di outer/inner diameter of the second cylindrical portion
Ce, Ci outer/inner cylindricity defect of the first cylindrical portion
ce, ci outer/inner cylindricity defect of the second cylindrical portion
JA Assembly clearance
JS Clearance after pressing

1. An automatic welding process for an assembly comprising:
a first tubular component comprising at least one first pressing surface and a first cylindrical portion, said first cylindrical portion having a first outer surface and a first inner surface, the first outer and inner surfaces not belonging to the at least one first pressing surface;
and a second tubular component comprising at least one second pressing surface and a second cylindrical portion, said second cylindrical portion having a second outer surface and a second inner surface, the second outer and inner surfaces not belonging to the at least one second pressing surface;
the automatic welding process involving
a pressing jig comprising at least one first receiving surface and at least one second receiving surface,
a pressing tool apt to form material radially along an axis,
a welding jig comprising at least at least one third receiving surface,
and a welding head,
the automatic welding process comprising the following steps:
positioning the first tubular component with respect to the pressing jig, by bringing the at least one first pressing surface into contact with the at least one first receiving surface,
clamping the first tubular component against the at least one first receiving surface so as to immobilize same,
freely fitting the second cylindrical portion of the second tubular component into the first cylindrical portion of the first tubular component, the second cylindrical portion being substantially coaxial with the first cylindrical portion,
placing the second tubular component with respect to the first tubular component and the pressing jig, by bringing the at least one second pressing surface into contact with the at least one second receiving surface,
“sliding” clamping the second tubular component against the at least one first receiving surface, the second tubular component being oriented by the at least one first receiving surface,
aligning the first and second cylindrical portions with the axis of the pressing tool,
pressing the first and second cylindrical portions by plastic deformation, the first and second tubular components in a pressed state forming a rigid assembly, the first and second cylindrical portions after being fitted and pressed defining a fitting and a joint, the rigid assembly thus formed further including at least one third pressing surface,
positioning the rigid assembly with respect to the welding jig,
clamping the rigid assembly against the welding jig,
welding the first tubular component to the second tubular component by positioning and orienting the welding head repeatably with respect to the fitting and the joint,
wherein positioning of the rigid assembly with respect to the welding jig is achieved by bringing the at least one third pressing surface into contact with the at least one third receiving surface, the at least one third pressing surface belonging to the first tubular component.

2. The process according to claim 1, wherein the at least one third pressing surface is identical to the at least one first pressing surface.

3. The process according to claim 1 comprising, prior to the step of positioning the first tubular component, a step of sleeving at least the first or second inner surface and/or at least the first or second outer surface.

4. The process according to claim 1, wherein pressing is performed by shrinking the first cylindrical portion against the second cylindrical portion.

5. The process according to claim 1, wherein pressing is performed by an expansion of the second cylindrical portion against the first cylindrical portion.

6. The process according to claim 1, wherein alignment and pressing are performed simultaneously.

7. The process according to claim 1, wherein welding is a laser lap welding of the fitting.

8. The process according to claim 1, wherein welding is an arc and lap welding of the joint.

9. The process according to claim 1, wherein the welding jig is a component of the pressing jig.

10. The process according to claim 1, wherein the pressing jig and the welding jig are distinct and wherein the rigid assembly is moved between pressing and welding.

11. The process according to claim 1, wherein the at least one third receiving surface is substantially identical and/or common to the at least one first receiving surface.

12. A pressing apparatus comprising:
a frame;
a pressing jig; and
a pressing tool having a pair of clamps, said pair of clamps being movable with respect to the frame between a loading position and a working position, the pair of clamps in the working position defining a first axis, the pressing jig being further apt to receive first and second tubular components with first and second cylindrical portions, respectively, the second cylindrical portion being freely fitted into the first cylindrical portion, the first and second cylindrical portions being substantially coaxial, wherein same includes an alignment device for alignment of fitted cylindrical portions with the first axis.

13. The pressing apparatus according to claim 12, wherein the pair of clamps are movable in translation with respect to the frame along a second axis perpendicular to the first axis and wherein the alignment device comprises at least one pivot connection mounted between the pressing jig and the frame.

14. The pressing apparatus according to claim 12, wherein the alignment device comprises at least one pivot connection along a third axis, where the first, second and third axes form a rectangular trihedron.

15. The pressing apparatus according to claim 12, wherein the alignment device comprises two pivot connections along corresponding third and fourth axes, where the first, second and third axes form a rectangular trihedron, and wherein the fourth axis is parallel to the second axis and intersects with the third axis.
